(19) United States
(12) Patent Application Publication
(10) Pub. No.: US 2013/0063928 A1
(43) Pub. Date: Mar. 14, 2013

(54) MULTIFUNCTIONAL COMPOUND LAMP

(71) Applicant: HUAN-PING LEE, Toufen Township (TW)

(72) Inventor: HUAN-PING LEE, Toufen Township (TW)

(21) Appl. No.: 13/231,949

(22) Filed: Sep. 13, 2011

(51) Int. Cl. F21V 33/00

(52) U.S. Cl. 362/101

(57) ABSTRACT

A multifunctional compound lamp includes a lamp base, which has a circumferential wall forming a plurality of light transmission apertures and receives and retains therein a lighting module and a heating module; a liquid receptacle, which is positioned on an upper end of the lamp base and is set adjacent to the heating module that is received in the lamp base; and a control circuit, which is arranged at a circumference of the lamp base and is electrically connected to the lighting module and the heating module in the lamp base. The control circuit includes a control knob that controls the lighting module and the heating module. When the control knob is actuated, the lighting module gives off light and the heating module carries out heating operation that heats and evaporates a liquid contained in the liquid receptacle to show different atmosphere through combination of lighting and scent smell.

### (a) TECHNICAL FIELD OF THE INVENTION

The present invention generally relates to a multifunctional compound lamp that provides presentation of lighting in combination with scents and is particularly applicable to indoor night lights or similar structures.

### (b) DESCRIPTION OF THE PRIOR ART

The progress of modern science and technology and the rise of income allow the modern people to be more demanding about living quality. Taking home living as an example, to realize physical and mental relaxation and to build up desired atmospheres, one of the most commonly used products is an aroma diffuser lamp. Conventional aroma diffuser lamps often use a candle or a tungsten filament bulb as a heating measure in order to produce essence gas that is released through evaporation. The structure of one conventional aroma diffuser lamp is to arrange a container that receives and holds an essence on a ceramic lantern and position a candle or a tungsten filament bulb in the lantern to provide heating to the container by which the essence gas is spread over an indoor space. A user may get emotional relaxation through physical perception of the smell of the essence gas.

However, although the conventional aroma diffuser lamp that uses a candle or a tungsten filament bulb as a heating source may release and spread the smell of the essence, yet the burning of candle causes poor and ill smell and consumes oxygen of indoor atmosphere and generates carbon dioxides that affects physical condition of the users. Further, accidental overturn the candle or user falling asleep during the use of the lamp might turn the burning candle into a dangerous killer for casualty and property loss. Further, candles and tungsten filament bulbs themselves do not have a functionality of color change, making the use and operation dull and boring. In addition, the tungsten filament bulbs are often of a great consumption of energy by converting a majority of the energy into heat and are also a cause for environmental pollution, making it impractical.

In view of the above discussed drawbacks of the conventional aroma diffuser lamps, the present invention aims to provide a safe and environmental-protection multifunctional compound lamp that overcomes the drawbacks.

### SUMMARY OF THE INVENTION

The primary objective of the present invention is to provide a multifunctional compound lamp that receives an aromatic agent for being presented in combination with lighting to exalt colorful and aromatic indoor atmosphere.

The secondary objective of the present invention is to provide a multifunctional compound lamp that realizes energy saving and carbon reduction through the characteristics of high efficiency and reduced power consumption of light-emitting diode (LED).

A further objective of the present invention is to provide a multifunctional compound lamp that is convertible into a device for sterilization and disinfection of air.

To achieve the above objectives, the present invention provides a multifunctional compound lamp comprises: a lamp base, which has a circumferential wall forming a plurality of light transmission apertures and receives and retains therein a lighting module and a heating module; a liquid receptacle, which is positioned on an upper end of the lamp base and is set adjacent to the heating module that is received in the lamp base; and a control circuit, which is arranged at a circumference of the lamp base and is electrically connected to the lighting module and the heating module in the lamp base. The control circuit comprises a control knob that controls the lighting module and the heating module.

In the multifunctional compound lamp mentioned above, the lamp base has a lower end to which a retention bracket is attached for accommodating the control circuit and the at least one control knob.

In the multifunctional compound lamp mentioned above, the retention bracket has a circumference to which a connector for connecting a power source is provided.

In the multifunctional compound lamp mentioned above, the connector of the retention bracket comprises a USB connector or a regular power plug.

In the multifunctional compound lamp mentioned above, the retention bracket is made of a material selected from glass fiber, glass, plastics, and ceramics.

In the multifunctional compound lamp mentioned above, the lighting module comprises a light-emission diode (LED) or a cold cathode fluorescent light (CCFL).

In the multifunctional compound lamp mentioned above, the liquid receptacle receives and retains therein a liquid that is selected from alcohol, aromatic substance, water, essence, perfume, fragrant liquid of natural plants, and any combination thereof.

In the multifunctional compound lamp mentioned above, the lamp base is made of a material selected from wood, ceramics, glass, plastics, and glass fiber.

In the multifunctional compound lamp mentioned above, the liquid receptacle is made of a material selected from glass, ceramics, plastics, and glass fiber.

In the multifunctional compound lamp mentioned above, the lamp base has a lower end coupled to a stand from which a power plug extends.

Compared to the existing devices, the present invention shows the following advantages:

(1) When a user places an aromatic agent in the lamp of the present invention, through a combined effect of lighting and heating by the lamp, no much extra energy is consumed and lighting is made in an energy-saving and carbon-reducing manner to change the indoor atmosphere for releasing reduction of pressure thereby releasing he pressure accumulated in the day.

(2) The user may selectively use a disinfectant liquid for sterilization of indoor air for removing harmful factors that are detrimental to human bodies from air.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of an embodiment according to the present invention.

FIG. 2 is an exploded view of the embodiment according to the present invention.

FIG. 3 is partial enlarged view of the embodiment according to the present invention.

FIG. 4 is a perspective view illustrating use of the embodiment according to the present invention.

FIG. 5 is a perspective view of a second embodiment according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

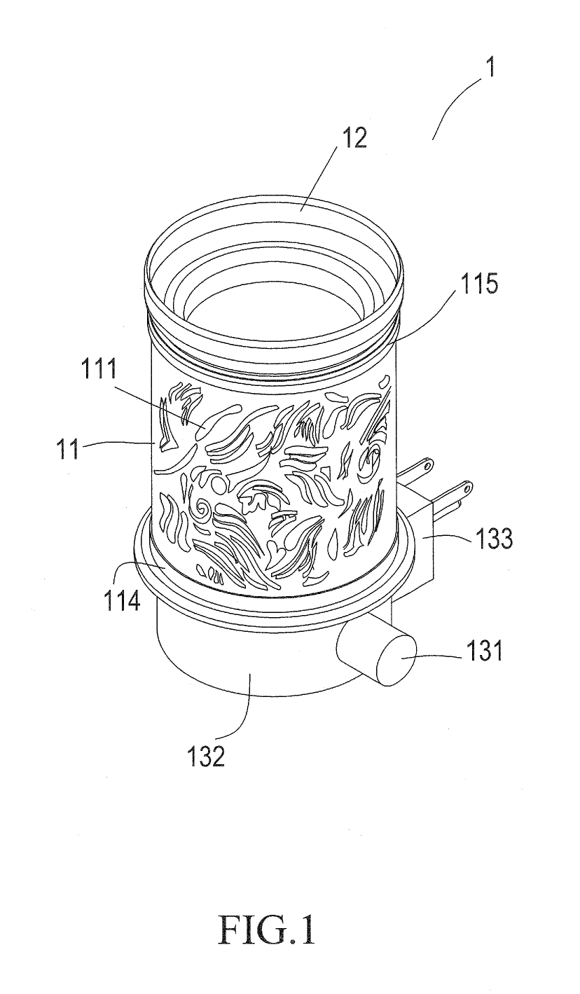

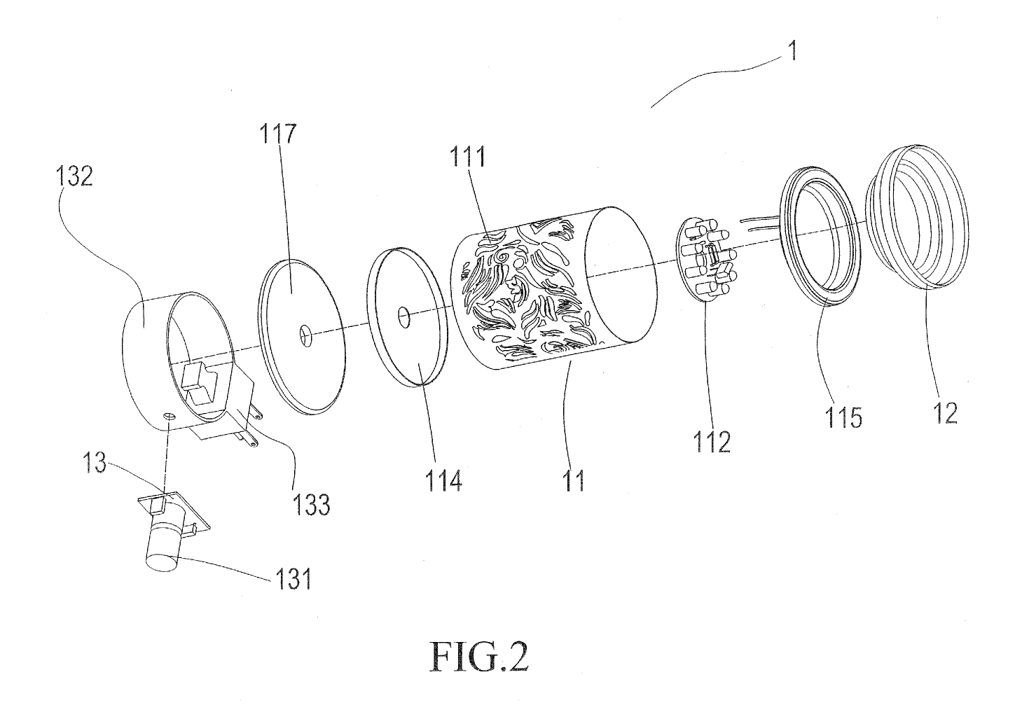

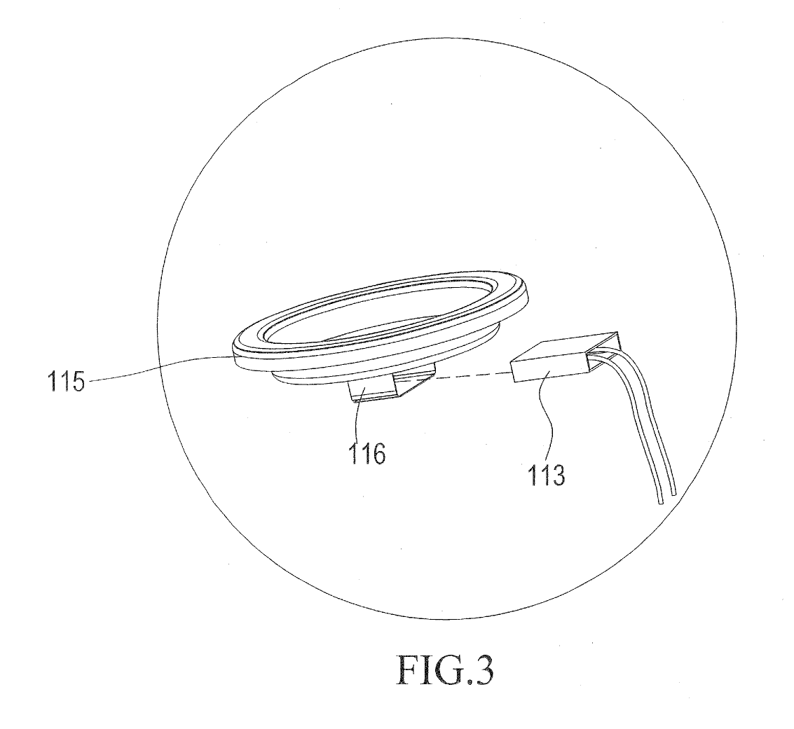

Referring to FIGS. 1 and 2, the present invention provides a multifunctional compound lamp 1, which comprises: a retention bracket 132, a lamp base 11, and a liquid receptacle 12. The lamp base 11 comprises a hollow tubular body, which has a circumferential wall forming a plurality of light transmission apertures 111. The lamp base 11 has a lower end to which a bottom lid 114 that forms a central through hole is attached. Further, the lamp base 11 receives and retains therein a lighting module 112 and a heating module 113. The lighting module 112 comprises a plurality of circumferentially arranged light-emission diodes and associated circuitry for controlling the plurality of light-emission diodes. The heating module 113 and the lighting module 112 are connected to each other. The heating module 113 and a top cover 115 are unitarily combined together. The top cover 115 has an interior portion that is downward recessed so that the top cover 115 can be properly fit to an upper end of the lamp base 11, as shown in FIG. 3. The top cover 115 has an underside that forms a mounting hole 116 that receives and retains the heating module 113 therein so that the heating module 113 is put in direct contact with the top cover 115 to allow the heat generated by the heating module 113 to be directly transmitted to the top cover 115.

The liquid receptacle 12 is recessed so as to correspond to the recessed configuration of the top cover 115 to be firmly positioned on the top cover 115 of the lamp base 11, whereby a large-area surface contact can be realized between a bottom of the liquid receptacle 12 and a bottom of the top cover 115.

A control circuit 13 is mounted to the retention bracket 132. A control knob 131 that is provided on the control circuit 13 is coupled to the control circuit 13 by extending through a through hole defined in the retention bracket 132, whereby the control knob 131 is exposed outside the retention bracket 132. Further, the retention bracket 132 comprises a power connector 133, which can be for example a USB connector or a regular power plug. In the instant embodiment, a regular power plug is taken as an example for illustration. The power plug is electrically connected to the control circuit 13. Further, the retention bracket 132 has an upper end that is coupled, through a separation plate 117 that forms a central through hole, to the lamp base 11. The lighting module 112 and the heating module 113 received in the lamp base 11 have electrical wires that extend through the central through holes of the bottom lid 114 and the separation plate 117 to electrically connect to the control circuit 13. And, this completes the assembling of the present invention.

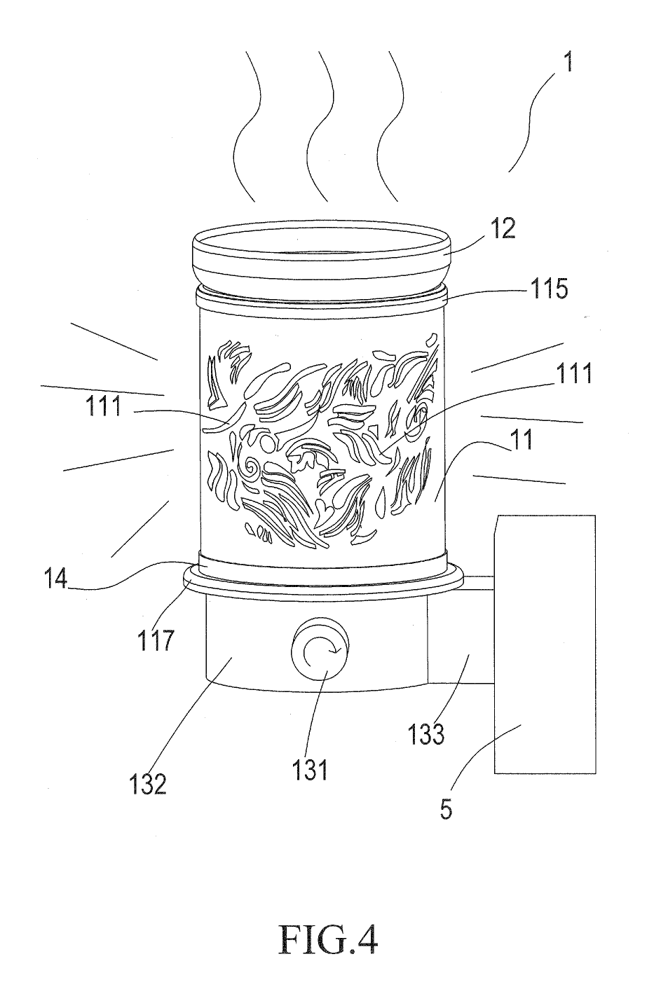

Referring to FIG. 4, the multifunctional compound lamp 1 according to the present invention uses the power plug of the power connector 133 to plug into and connect with a household power socket 5. Then, an essence is introduced into the liquid receptacle 12. Afterwards, the control knob 131 is turned or otherwise actuated to activate the lighting module 112 and the heating module 113 so that light emitting from the lighting module 112 may transmit through the light transmission apertures 111 to project outward. Meanwhile, with the heating module 113 applying heat to the top cover 115 and the top cover 115 transmitting heat therethrough, the essence received in the liquid receptacle 12 is heated to release aromatic smell that changes the indoor atmosphere to realize reduction of pressures thereby releasing the pressure accumulated in the day.

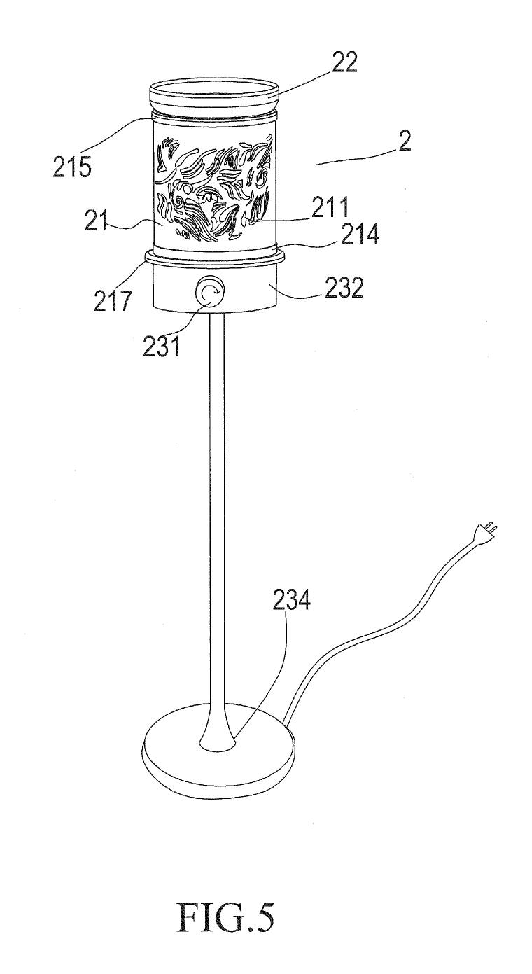

Referring to FIG. 5, a second embodiment of the present invention is illustrated, providing a multifunctional compound lamp 2 of which the structure is substantially identical to that of the first embodiment and comprises a lamp base 21, a liquid receptacle 22, and a retention bracket 232. The lamp base 21 forms a plurality of light transmission apertures 211. The lamp base 21 has a lower end to which a bottom lid 214 that forms a central through hole is attached. Further, the lamp base 21 receives and retains therein a lighting module and a heating module (not shown in FIG. 5 but a feasible arrangement being shown in the example of FIG. 2). The heating module and the lighting module are connected to each other. The heating module and a top cover 215 are unitarily combined together. The top cover 215 is fit to an upper end of the lamp base 21, and the liquid receptacle 22 is positioned on the top cover 215. The bottom lid 214 of the lamp base 21 is coupled, through the separation plate 217, to the retention bracket 232. A control circuit (no shown) is received in the retention bracket 232 and the control circuit is connected to a control knob 231 that is exposed outside the retention bracket 232. The retention bracket 232 has a lower end that is coupled to a stand 234. A power connection portion comprises electrical wires that extends through an interior space of the stand 234 to the bottom and further extends externally to form a power plug.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multifunctional compound lamp, comprising:
a lamp base, which has a circumferential wall fanning a plurality of light transmission apertures, the lamp base receiving and retaining therein a lighting module and a heating module;
a liquid receptacle, which is positioned on an upper end of the lamp base and is set adjacent to the heating module that is received in the lamp base; and
a control circuit, which is arranged at a circumference of the lamp base and is electrically connected to the lighting module and the heating module in the lamp base, the control circuit comprising at least one control knob that controls the lighting module and the heating module.

2. The multifunctional compound lamp according to claim 1, wherein the lamp base has a lower end to which a retention bracket is provided for accommodating the control circuit and the at least one control knob.

3. The multifunctional compound lamp according to claim 2, wherein the retention bracket has a circumference to which a connector for connecting a power source is provided.

4. The multifunctional compound lamp according to claim 2, wherein the connector of the retention bracket comprises a USB connector or a regular power plug.

5. The multifunctional compound lamp according to claim 2, wherein the retention bracket is made of a material selected from glass fiber, glass, plastics, and ceramics.

6. The multifunctional compound lamp according to claim 1, wherein the lighting module comprises a light-emission diode (LED) or a cold cathode fluorescent light (CCFL).

7. The multifunctional compound lamp according to claim 1, wherein the lamp base has an upper end to which a thermally conductive top cover is provided, the top cover having an underside forming a mounting hole to which the heating module is coupled.

8. The multifunctional compound lamp according to claim 1, wherein the liquid receptacle receives and retains therein a liquid that is selected from alcohol, aromatic substance, water, essence, perfume, fragrant liquid of natural plants, and any combination thereof.

9. The multifunctional compound lamp according to claim 1, wherein the lamp base is made of a material selected from wood, ceramics, glass, plastics, and glass fiber.

10. The multifunctional compound lamp according to claim 1, wherein the liquid receptacle is made of a material selected from glass, ceramics, plastics, and glass fiber.

11. The multifunctional compound lamp according to claim 1, wherein the lamp base has a lower end coupled to a stand from which a power plug extends.
